(19) United States
(12) Patent Application Publication
(10) Pub. No.: US 2010/0064907 A1
(43) Pub. Date: Mar. 18, 2010

(54) DIE CHANGING METHOD OF PRESS MACHINE AND PRESS MACHINE

(75) Inventor: Motonao Niizuma, Tokyo (JP)

Correspondence Address: GRIFFIN & SZIPL, PC, SUITE PH-1, 2300 NINTH STREET, SOUTH, ARLINGTON, VA, 22204, US

(73) Assignee: IHI CORPORATION, Tokyo (JP)

(21) Appl. No.: 12/375,134

(22) PCT Filed: Jul. 20, 2007
(86) PCT No.: PCT/JP2007/064355

§ 371 Date: Jan. 26, 2009

(30) Foreign Application Priority Data
Jul. 25, 2006 (JP) 201624/2006

(51) Int. Cl. B30B 15/14

(52) U.S. Cl. 100/35; 100/299

(57) ABSTRACT

The invention provides a die changing method of a press machine which can drastically shorten a time required for changing the die. In a press machine (a servo driving type press machine) capable of positioning a slide at an arbitrary position by controlling a servo motor, a time required for moving the slide is shortened by moving the slide in a range necessary for changing the die. Further, it is possible to omit an operation of a slide adjusting mechanism by controlling the servo motor so as to position and control the slide without operating the slide adjusting mechanism, and moving the slide at a height suitable for changing the die, thereby quickening a die changing work.

### BACKGROUND OF THE INVENTION

1. Field of the Invention

The present invention relates to a die changing method of a press machine and a press machine.

2. Description of the Related Art

A press machine is classified in accordance with a generating mechanism of a pressure, and can be roughly classified into “hydraulic press” using a fluid pressure, and “mechanical press” on the basis of a mechanical driving force. In general, since the mechanical press has a higher productivity and an easy maintenance, a press work is mostly executed by the mechanical press.

FIG. 1 is a view showing a schematic structure of a conventional general mechanical press 40. As shown in FIG. 1, a bed 41 is arranged in a lower portion of the mechanical press 40, and a bolster 42 for mounting and fixing a lower die 44 is installed on the bed 41. A slide 45 is provided above the bolster 42 so as to be movable up and down. An upper die 43 is fixed to a lower surface of the slide 45 by a die clamper 57. A drive shaft 46 is rotatably supported to an upper portion of the mechanical press 40. A flywheel 47 and a clutch 48 are arranged in one end side of the drive shaft 46.

A timing belt 51 is wound between the flywheel 47, and a pulley 50 installed to an output shaft of a main motor 49. A kinetic energy is accumulated in the flywheel 47 on the basis of a rotational drive of the main motor 49, and the drive shaft 46 is rotationally driven by discharging the energy via the clutch 48. A pinion gear 52 is attached to the drive shaft 46, and the pinion gear 52 is engaged with a main gear 54 attached to a crank shaft 53. A connecting rod 55 is rotatably coupled to an eccentric portion 53a of the crank shaft 53. The connecting rod 55 is coupled to the slide 45 via a slide adjusting mechanism 56. The slide adjusting mechanism 56 is structured such as to adjust a die height (a height between a lower surface of the slide 45 and an upper surface of the bolster at a time when the slide 45 exists at a bottom dead point) by changing a vertical position of the slide at a slide bottom dead point.

In the mechanical press 40 structured as mentioned above, the kinetic energy is accumulated by rotating the flywheel 47 on the basis of the rotational drive of the main motor 49, the kinetic energy of the flywheel 47 is released by setting the clutch 48 in a connected state, a power is transmitted via the drive shaft 46, the pinion gear 52 and the main gear 54, and a rotational movement is converted into a linear movement via the crank shaft 53 and the connecting rod 55, whereby the slide 45 moves up and down between a top dead point and the bottom dead point. Further, in the mechanical press 40 structured as mentioned above, since the movement of the slide 45 is controlled by the clutch 48, a position at which the slide 45 can be regularly stopped is limited generally to the top dead point and the bottom dead point. The flywheel 47 is generally rotated in one direction, and it is hard to change a rotating direction.

In the mechanical press 40, in order to use the die appropriate for a kind of a press product to be produced, a die change is executed. A description will be given of a procedure of a die change of the conventional mechanical press 40 with reference to FIG. 2. In the following description, “current dies” means upper and lower dies before being changed, and “next dies” means upper and lower dies after being changed.

(Start)

After finishing a production by the current dies, the slide 45 stops at the top dead point. At this time, the slide adjusting mechanism 56 is adjusted such that a slide lower surface at the slide bottom dead point comes to a height for producing by the current dies. Hereinafter, the slide adjusting height at this time is called as “current die producing slide adjusting height”.

(Step 1)

The slide adjusting mechanism 56 is operated and is adjusted such that the slide lower surface at the slide bottom dead point comes to a height for unclamping the upper die 43 of the current dies (a height suitable for unclamping the upper die 43 after mounting the upper die 43 on the lower die 44). Hereinafter, the slide adjusting height at this time is called as “current die unclamping slide adjusting height”.

The slide adjusting height is changed from “current die producing slide adjusting height” to “current die unclamping slide adjusting height” on the basis of this adjusting.

(Step 2)

The clutch 48 is connected, and the slide 45 is moved from the top dead point to the bottom dead point. At this time, the slide 45 stops at a position at which the upper die 43 just gets on the lower die 44.

(Step 3)

The die clamper 57 is operated, and the upper die 43 of the current dies is unclamped. Accordingly, the upper die 43 of the current dies is unclamped from the slide 45.

(Step 4)

The clutch 48 is connected, and the slide 45 is moved from the bottom dead point to the top dead point.

(Step 5)

The slide adjusting mechanism 56 is operated and is adjusted such that the slide lower surface at the slide bottom dead point comes to a height for clamping the upper die 43 of the next dies (a height suitable for clamping the upper die 43 mounted on the lower die 44). The slide adjusting height at this time is called as “next die clamping slide adjusting height”. The slide adjusting height is changed from “current die unclamping slide adjusting height” to “next die clamping slide adjusting height” on the basis of this adjusting.

In parallel, the upper die and the lower die of the current dies are taken out from the mechanical press 40, and the upper die and the lower die of the next dies are mounted on the bolster 42 of the mechanical press 40.

(Step 6)

The clutch 48 is connected so as to move the slide 45 from the top dead point to the bottom dead point.

(Step 7)

The die clamper 57 is operated so as to clamp the upper die 43 of the next dies. Accordingly, the upper die 43 of the next dies is fixed to the slide 45.

(Step 8)

The clutch 48 is connected so as to move the slide 45 from the bottom dead point to the top dead point.

(Step 9)

The slide adjusting mechanism 56 is operated and is adjusted such that the slide lower surface at the slide bottom dead point comes to a height for producing by the next dies. Hereinafter, the slide adjusting height at this time is called as “next die producing slide adjusting height”. The slide adjusting height is changed from “next die clamping slide adjusting height” to “next die producing slide adjusting height” on the basis of this adjusting.

(End)

The production by the next dies is available.

The following patent documents 1 to 4 show prior arts relating to the mechanical press mentioned above.

The patent document 1 discloses a mechanical press provided with a drive system including a flywheel and a clutch.

The patent document 2 discloses a slide adjusting mechanism employing a screw mechanism.

The patent documents 3 and 4 disclose a mechanical press employing a power transmitting mechanism in which a slide is moved down slowly and is moved up quickly at a time when a shaft serving as a slide driving source is rotated at a fixed speed in one direction.

Patent Document 1: Japanese Unexamined Patent Publication No. 2004-34111

Patent Document 2: Japanese Utility Model Publication No. 61-24392

Patent Document 3: Japanese Patent Publication No. 46-29224

Patent Document 4: Japanese Unexamined Patent Publication No. 2003-320489

In the conventional mechanical press 40 mentioned above, the following problems exist at a time of changing the die.

(1) Since the slide 45 reciprocates again and again between the top dead point and the bottom dead point, a long time is required for this reciprocation.

(2) As an adjusting mechanism of the slide adjusting mechanism 56, the screw mechanism as shown in the patent document 2 is generally employed, however, since a moving speed of the screw mechanism mentioned above is extremely slow, it takes a long time to adjust.

(3) In the structure employing the power transmitting mechanism such as the patent documents 3 and 4, the downward movement of the slide 45 is slow while moving up and down the slide 45 for replacing the die, and it takes a long time to move the slide 45.

### SUMMARY OF THE INVENTION

The present invention is made by taking the problems mentioned above into consideration, and an object of the present invention is to provide a die changing method of a press machine which can drastically shorten a time required for changing the die, and a press machine.

In order to solve the problems mentioned above, the die changing method of the press machine and the press machine in accordance with the present invention employ the following means.

(1) In accordance with the present invention, there is provided a die changing method of a press machine capable of positioning a slide at an arbitrary position within a slide moving range by transmitting a rotating motion of a servo motor serving as a press driving source for an elevating motion of a slide via a power transmitting mechanism and controlling the servo motor, comprising:

a step of moving the slide to a position at which an upper die gets on a lower die;

a step of unclamping the upper die from the slide;

a step of moving up the slide to a predetermined position which does not reach a top dead point so as to make it on standby;

a step of taking out the upper and lower dies from the press machine and bringing the other upper and lower dies in the press machine;

a step of moving down the slide to a position for clamping the upper die to the slide;

a step of clamping the upper die to the slide; and

a step of moving up the slide to a position at which a start of a press work is allowed.

In the conventional mechanical press mentioned above, the slide stop position is limited to the top dead point and the bottom dead point, however, since the present invention aims at the press machine (a servo driving type press machine) capable of positioning the slide to an arbitrary position by controlling the servo motor, it is not necessary to move the slide to the top dead point in the die change. Accordingly, since it is sufficient to move the slide in a range necessary and sufficient for a die changing work, it is possible to drastically shorten a time required for moving the slide.

(2) Further, in the die changing method of the press machine mentioned above, the press machine has a slide adjusting mechanism adjusting a die height, and the method includes a step of operating the slide adjusting mechanism so as to change a height of the slide adjusting mechanism from an adjusting height for executing a press work by an original die to an adjusting height for executing a press work by the next die.

In this case, the “original dies” mentioned above corresponds to “current dies” (the dies before being changed) in the embodiment. The “next dies” mentioned above corresponds to “next dies” (the dies after being changed) in the embodiment.

In the case of the mechanical press having the slide adjusting mechanism, it is necessary to change the die height adjusting position three times in the conventional mechanical press (refer to steps 1, 5 and 9 in FIG. 2). On the contrary, in accordance with the present invention, since it is sufficient to execute the change for corresponding to the difference of the die, and it is possible to correspond to the steps 1 and 9 in the conventional die change by controlling the positioning of the slide, it is possible to omit the operation of the slide adjusting mechanism. Accordingly, it is possible to drastically shorten the time required for the operation of the slide adjusting mechanism.

(3) Further, in the die changing method of the press machine mentioned above, the step of changing the height of the slide adjusting mechanism is executed in parallel to a step of taking out the upper and lower dies from the press machine and bringing the other upper and lower dies in the press machine.

It is possible to efficiently make progress the changing work so as to rapidly execute the die change by executing the step of changing the slide adjusting height in parallel to the step of taking out the upper and lower dies from the press machine and bringing the other upper and lower dies in the press machine.

(4) Further, in the die changing method of the press machine mentioned above, the power transmitting mechanism of the press machine is constituted by a mechanism in which the slide repeats an elevation with respect to a rotation in one direction of the servo motor and moving amounts of the slide becomes asymmetric between a downward moving time and an upward moving time with respect to an angle of rotation of the servo motor, thereby moving up and down the slide by utilizing a section in the side that the moving amount is larger with respect to the angle of rotation of the servo motor, in the step including the movement of the slide in each of the steps.

As mentioned above, since the slide is moved up and down by utilizing the section in the side in which the moving amount is larger with respect to the angle of rotation of the servo motor, it is possible to shorten a moving time of the slide.

Further, in accordance with the present invention, there is provided a press machine comprising:

a servo motor serving as a press driving source;

a slide in which an upper die is attached to a lower surface so as to move up and down;

a die clamper fixing an upper die to the lower surface of the slide so as to be capable of being unclamped;

a power transmitting mechanism converting a rotational motion of the servo motor into an elevating motion of the slide; and

a control unit controlling at least the servo motor and the die clamper;

wherein the control unit capable of positioning the slide at an arbitrary position within a slide moving range by controlling the servo motor,

the control unit moves the slide at a position at which the upper die gets on the lower die at a time of changing the die, next controls the die clamper so as to unclamp the upper die from the slide, next controls the servo motor so as to move up the slide to a predetermined position which does not reach a top dead point and make the slide on standby, moves down the slide to a position for fixing the upper die to the slide after the upper and lower dies are taken out from the press machine and the other upper and lower dies are brought in the press machine, next controlling the die clamper so as to fix the upper die to the slide, and next controlling the servo motor in such a manner as to move up the slide to a position at which a start of a press work is allowed.

Further, in the press machine mentioned above, the press machine is further provided with a slide adjusting mechanism adjusting a die height, and the control unit controls the slide adjusting mechanism in such a manner as to change a height of the slide adjusting mechanism for an adjusting height for pressing by the original dies to an adjusting height for pressing by the next dies, at a time of changing the die.

Further, in the press machine mentioned above, the control unit executes the control for changing the height of the slide adjusting mechanism at a time of changing the die in parallel to a work that the upper and lower dies are taken out from the press machine and the other upper and lower dies are brought in the press machine.

Further, in the press machine mentioned above, the power transmitting mechanism of the press machine is constituted by a mechanism in which the slide repeats an elevation with respect to a rotation in one direction of the servo motor and moving amounts of the slide becomes asymmetric between a downward moving time and an upward moving time with respect to an angle of rotation of the servo motor, and the control unit controls the servo motor in such a manner as to move up and down the slide by utilizing a section in the side that the moving amount is larger with respect to the angle of rotation of the servo motor, at a time when the slide moves at a time of changing the die.

In accordance with the press machine mentioned above, it is possible to execute the die changing method of the press machine mentioned above.

In accordance with the present invention, it is possible to obtain an excellent effect that it is possible to drastically shorten a time required for changing the die.

### BRIEF DESCRIPTION OF THE DRAWINGS

FIG. 1 is a view of a schematic structure of a mechanical press used for executing a die changing method in accordance with a conventional example;

FIG. 2 is a view explaining a procedure of the die changing method in accordance with the conventional example;

FIG. 3 is a view of a schematic structure of a servo press used for executing a die changing method in accordance with the present invention;

FIG. 4A is a view explaining a positional relation between a top dead point and a bottom dead point in the servo press in FIG. 3;

FIG. 4B is a view explaining a positional relation between a lower end of a power transmitting mechanism and a slide lower surface in the servo press in FIG. 3;

FIG. 5 is a view explaining a procedure of a die changing method in accordance with the present invention;

FIG. 6A is a view showing a height of a slide lower surface at a time of producing by current dies in accordance with the die changing method of the present invention;

FIG. 6B is a view showing a height of the slide lower surface at a time of unclamping the current dies in accordance with the die changing method of the present invention;

FIG. 6C is a view showing a height of a slide lower surface at a time of clamping a next dies in accordance with the die changing method of the present invention;

FIG. 6D is a view showing a height of the slide lower surface at a time of producing by the next dies in accordance with the die changing method of the present invention;

FIG. 7A is a view showing a height of a slide lower surface at a time of producing by current dies in accordance with the die changing method of the conventional example;

FIG. 7B is a view showing a height of the slide lower surface at a time of unclamping the current dies in accordance with the die changing method of the conventional example;

FIG. 7C is a view showing a height of a slide lower surface at a time of clamping next dies in accordance with the die changing method of the conventional example;

FIG. 7D is a view showing a height of the slide lower surface at a time of producing by the next dies in accordance with the die changing method of the conventional example; and

FIG. 8 is a view showing a relation between a crank angle and a slide displacement in some sort of power transmitting mechanism.

### DESCRIPTION OF THE PREFERRED EMBODIMENTS

A description will be in detail given below of a preferable embodiment in accordance with the present invention with reference to the accompanying drawings. In this case, the same reference numerals are attached to the common portions in the drawings, and an duplicate description will be omitted.

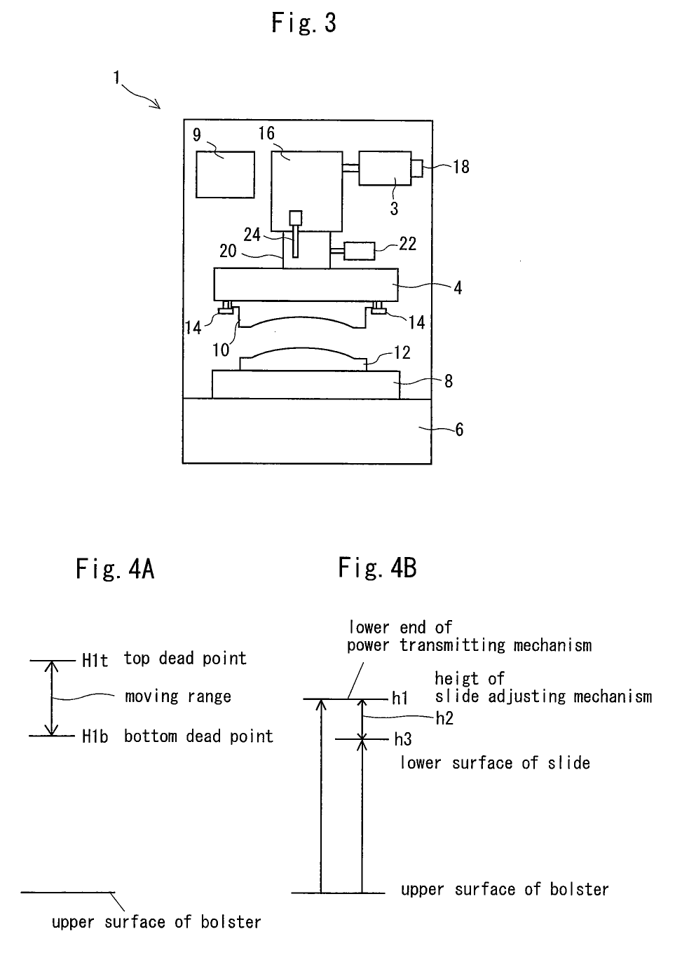

FIG. 3 is a view showing a schematic structure of a press machine in accordance with the present invention. The press machine 1 is constituted by a servo driving type press machine (hereinafter, referred to as a servo press) which can position a slide 4 at an arbitrary position within a slide movement range by controlling a servo motor 3.

The servo press 1 is provided with a slide 4 freely moving up and down above a bolster 8 installed on a bed 6, and is structured such as to press a work between an upper die 10 and a lower die 12. The upper die 10 is attached to a lower surface of the slide 4, and the lower die 12 is fixed onto the bolster 8. The slide 4 is provided with a die clamper 14 fixing the upper die 10 to the lower surface of the slide 4 so as to be freely unclamped.

The servo press 1 is provided with the servo motor 3 as a driving source. A rotational motion of the servo motor 3 is converted into a linear motion (an elevating motion) by a power transmitting mechanism 16. The power transmitting mechanism 16 can be achieved, for example, by a combination of a crank shaft and a link such as the patent document 4 mentioned above, by a link mechanism such as Japanese Unexamined Patent Publication No. 2003-290984, and the like.

A rotational position of the servo motor 3 is detected by a rotational position detector 18. It is possible to calculate a position of a lower end of the power transmitting mechanism 16 on the basis of a detected data, and of a conversion formula determined by a mechanism of the power transmitting mechanism 16. Further, the structure is made such that it is possible to control the rotational position of the servo motor 3 so as to move the lower end of the power transmitting mechanism 16 to an arbitrary position by executing a position feedback control as occasion demands. The rotational position detector 18 can be achieved, for example, by an optical type rotary encoder, a resolver or the like.

The power transmitting mechanism 16 is coupled to the slide 4 via a slide adjusting mechanism 20. The slide adjusting mechanism 20 is structured such as to adjust a die height by changing a vertical position of the slide 4 at the slide bottom dead point. The slide adjusting mechanism 20 can be achieved, for example, by a feed screw type mechanism as shown in the patent document 2 mentioned above (Japanese Utility Model Publication No. 61-24392). The height of the slide adjusting mechanism 20 can be changed by rotating a slide adjusting mechanism driving motor 22. Accordingly, it is possible to adjust a die height adjusting position. Even if the servo motor 3 is not rotated, it is possible to finely adjust a height of the slide 4.

A height of the slide adjusting mechanism 20 can be measured by a slide adjusting mechanism height measuring device 24, and it is possible to optionally adjust the height of the slide adjusting mechanism 20 by executing a position feedback control as occasion demands. The slide adjusting mechanism height measuring device 24 can be achieved, for example, by a linear encoder or a linear scale.

The control unit 9 controls the servo motor 3, the die clamper 14 and the slide adjusting mechanism 20. The control unit 9 controls the servo motor 3, thereby positioning the slide 4 at an arbitrary position within the slide movement range.

In the servo press 1 structured as mentioned above, a pressing of a work is executed by adjusting the height of the slide adjusting mechanism 20 at a height suitable for a pressing by rotationally driving the slide adjusting mechanism driving motor 22, thereafter moving up and down the slide 4 via the power transmitting mechanism 16 by rotating the servo motor 3, and making the upper die 10 and the lower die 12 come close to each other at a distance necessary for the pressing.

As shown in FIG. 4A, a lower end position of the power transmitting mechanism 16 is changed between a top dead point existing at a height H1t from an upper surface of the bolster 8, and a bottom dead point existing at a height H1b from the upper surface of the bolster 8, by rotating the servo motor 3.

As shown in FIG. 4B, it is assumed that reference symbol h1 denotes a height of the lower end of the power transmitting mechanism 16 from the upper surface of the bolster 8 at a certain time, and reference symbol h2 denotes to a height of the slide adjusting mechanism 20. Further, since a thickness of the slide 4 is not changed, the thickness of the slide 4 is conveniently set to 0 in this case (in other words, the lower end of the slide adjusting mechanism 20 coincides with the lower end of the slide 4 in this case). In this case, a lower surface position h3 of the slide 4 with respect to the upper surface of the bolster 8 is given by an expression h3=h1−h2. In this case, a relation H1b≦h1≦H1t holds.

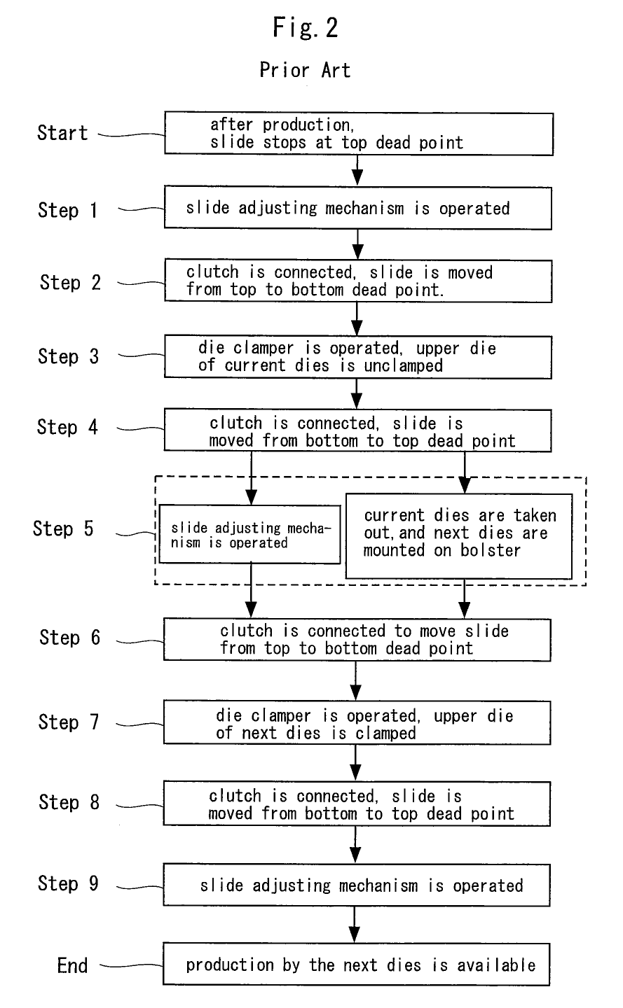

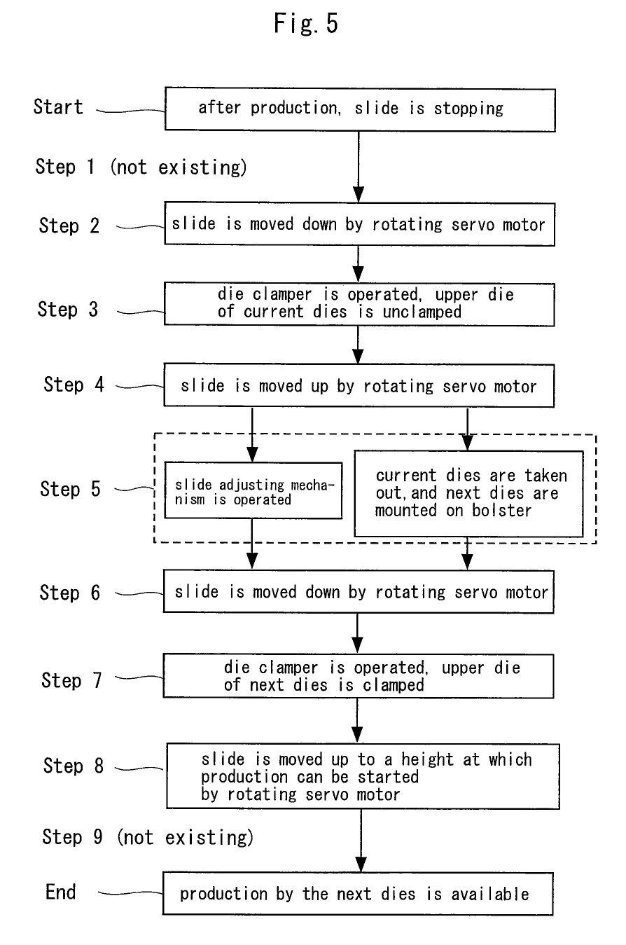

FIG. 5 is a view showing a procedure of a die changing method of a press machine in accordance with the present invention. In FIG. 5, in order to be in contrast with the procedure of the die changing method of the press machine in accordance with the prior art shown in FIG. 2, the corresponding motions are denoted by the same step numbers.

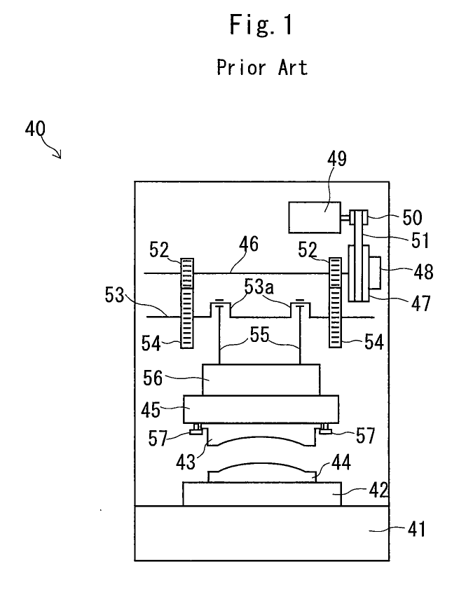

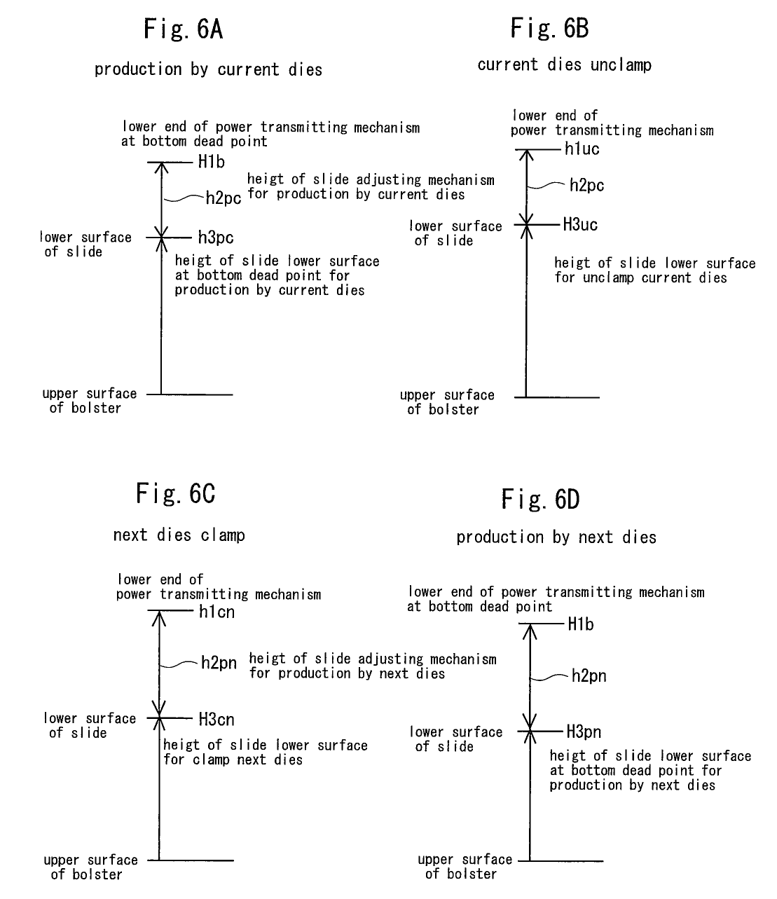

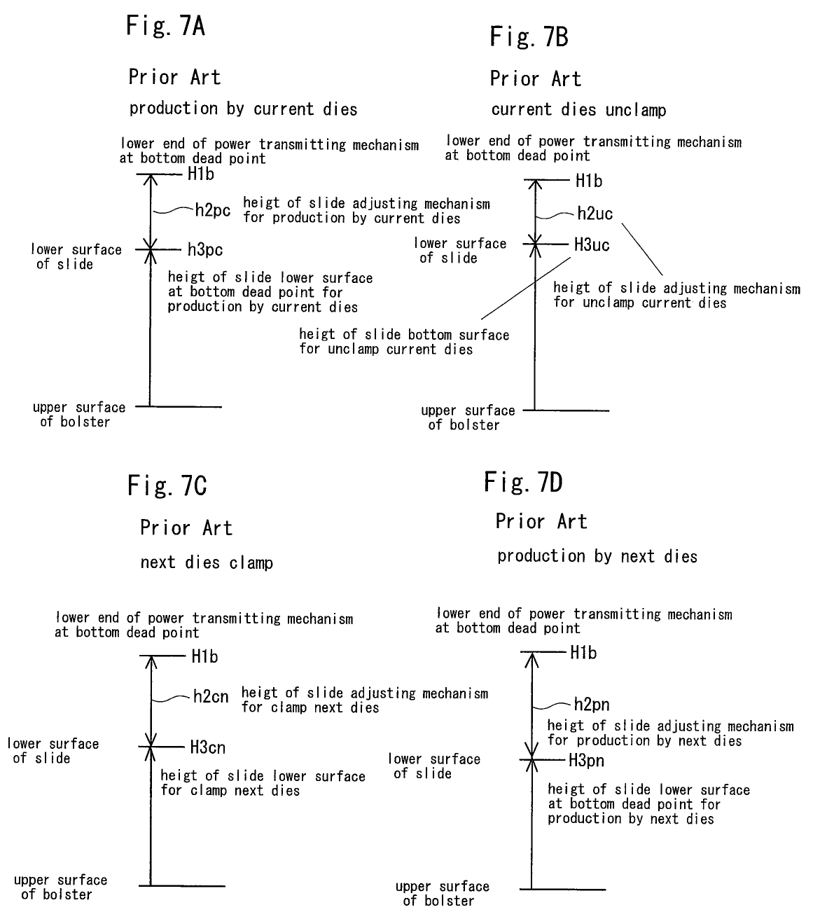

Further, FIGS. 6A to 6D show a change of the lower surface height of the slide 4 at a time of executing the die changing method in accordance with the present invention, and FIGS. 7A to 7D show a change of the slide lower surface at a time of executing the conventional die changing method. The crank shaft 53 and the connecting rod 55 in FIG. 1 correspond to “power transmitting mechanism” of the prior art in FIGS. 7A to 7D.

In this case, in the following description, “current dies” refer to upper and lower dies before being changed, and “next dies” refer to upper and lower dies after being changed.

As shown in FIGS. 6A and 7A, if the height of the slide lower surface at the bottom dead point for producing by the current dies is denoted by h3pc, the height of the slide adjusting mechanism 20 comes to h2pc=H1b−h3pc, while being produced by the current dies. This is identical both in the present invention and in the prior art. In the same manner as in FIG. 4, since the thickness of the slide 4 is not changed, the thickness of the slide 4 is conveniently set to 0 in this case (in other words, the lower end of the slide adjusting mechanism 20 coincides with the lower end of the slide 4 in this case).

The die changing method in accordance with the present invention is executed by the following procedures.

(Start)

Referring to FIG. 5, after finishing a production by the current dies, the slide 4 is stopped. At this time, the slide adjusting mechanism 20 is adjusted such that the lower surface of the slide 4 at the bottom dead point of the slide 4 comes to a height for producing by the current dies (current die producing slide adjusting height).

(Step 1)

In the die changing method in accordance with the present invention, since the corresponding stage to the step 1 of the prior art is not provided, the step goes to a step 2.

(Step 2)

Under the control by the control unit 9, the slide 4 is moved down by rotating the servo motor 3. At this time, the slide 4 stops at a position at which the upper die 10 just gets on the lower die 12. In this case, as shown in FIG. 6B, a height at which the lower surface of the slide 4 is stopped for unclamping the current dies is denoted by H3uc.

As shown in FIG. 7B, in the prior art, the lower end of the power transmitting mechanism 16 is stopped at the bottom dead point, that is, at the height H1b, after operating the slide adjusting mechanism 20 such that the height (the total height) of the slide adjusting mechanism 20 comes to h2uc=H1b−H3uc.

On the contrary, in accordance with the present invention, the servo motor 3 is controlled such that the lower end position of the power transmitting mechanism 16 comes to h1uc=h2pc+H3uc while keeping the height of the slide adjusting mechanism 20 at h2pc. Therefore, in accordance with the present invention, it is possible to omit a time for changing the height of the slide adjusting mechanism 20 in comparison with the prior art.

(Step 3)

Under the control by the control unit 9, the die clamper 14 is operated so as to unclamp the upper die 10 of the current dies. Therefore, the upper die 10 of the current dies is unclamped from the slide 4.

(Step 4)

Under the control by the control unit 9, the servo motor 3 is rotated so as to move up the slide 4 to a predetermined position which does not reach the top dead point and make it on standby. Specifically, the slide 4 is moved up in such a manner as to prevent the die, the slide 4 and accessories (not shown) thereof from being interfered with the die at a time of taking in and bringing out the current dies and the next dies after unclamping the current dies.

The slide 4 is moved up to the top dead point in the prior art. On the contrary, in accordance with the present invention, the servo motor 3 is controlled such that the slide 4 and the accessories thereof are moved up to a minimum height forming no obstacle for taking in and bringing out the current dies and the next dies. Accordingly, the present invention can shorten an upward moving distance of the slide 4, that is, a time required for moving, in comparison with the prior art.

In this case, it is possible to determine how high the slide 4 should be moved up actually, on the basis of several means such as a visual estimation by an actual machine, a study on the drawing, a utilization of an interference check function of a CAD software, and the like.

(Step 5)

Under the control by the control unit 9, the slide adjusting mechanism 20 is operated so as to adjust such that the lower surface of the slide 4 at the bottom dead point of the slide 4 comes to a height for producing by the next dies (a next die producing slide adjusting height). The slide adjusting height is changed from “current die producing slide adjusting height” to “next die producing slide adjusting height” on the basis of this adjusting.

In parallel, the upper die and the lower die of the current dies are taken out from the servo press 1, and the upper die and the lower die of the next dies are mounted on the bolster 8 of the servo press 1 in such a state that the upper die of the next die sits on the lower die of the next dies.

(Step 6)

Under the control by the control unit 9, the servo motor 3 is rotated so as to move down the slide 4.

In this case, as shown in FIG. 6C, a height at which the slide lower surface is stopped for clamping the next dies is denoted by H3cn.

As shown in FIG. 7C, in the prior art, the lower end of the power transmitting mechanism 16 is stopped at the bottom dead point, that is, the height H1b, after operating the slide adjusting mechanism 20 in such a manner that the height of the slide adjusting mechanism 20 comes to h2cn=H1b−H3cn.

On the contrary, in accordance with the present invention, the servo motor 3 is controlled in such a manner that the lower end position of the power transmitting mechanism 16 comes to h1cn=h2pn+H3cn, after changing the height (the total height) of the slide adjusting mechanism 20 to h2pn=H1bH3pn. In this case, reference symbol H3pn denotes a height of the slide lower surface at the bottom dead point for producing by the next dies.

Accordingly, in the prior art, the lower end of the power transmitting mechanism 16 starts moving from the top dead point, however, in accordance with the present invention, since the lower end of the power transmitting mechanism 16 starts moving from the position lower than the top dead point, it is possible to shorten the time required for moving.

(Step 7)

Under the control by the control unit 9, the upper die 10 of the next dies is clamped by operating the die clamper 14. Accordingly, the upper die 10 of the next dies is fixed to the slide 4.

(Step 8)

Under the control by the control unit 9, the servo motor 3 is rotated so as to move up the slide 4 to a height at which the production can be started.

(Step 9)

As shown in FIG. 7D, in the prior art, the slide adjusting mechanism 20 is operated in such a manner that the height of the slide adjusting mechanism 20 comes to h2pn. On the contrary, as shown in FIG. 6D, in accordance with the present invention, since the height of the slide adjusting mechanism 20 has already come to h2pn, it is possible to omit the operation of the slide adjusting mechanism 20. Therefore, in accordance with the die changing method of the present invention, the corresponding stage to the stop 9 of the prior art does not exist.

(End)

The production by the next dies can be allowed.

As mentioned above, in the case of the press machine having the slide adjusting mechanism 20, it is necessary to execute the change of the die height adjusting position three times in the conventional mechanical press (the steps 1, 5 and 9 in FIG. 2). On the contrary, in accordance with the present invention, since it is sufficient to execute only the change for corresponding to the difference of the die, and it is possible to deal with the steps 1 and 9 of the conventional die change by the positioning control of the slide 4, it is possible to omit the operation of the slide adjusting mechanism 20. Therefore, it is possible to drastically shorten the time required for the operation of the slide adjusting mechanism 20.

Further, it is possible to efficiently make progress the changing work so as to rapidly execute the die change by executing the step of changing the slide adjusting height in parallel to the step of taking out the upper and lower dies from the press machine and bringing the other upper and lower dies in the press machine.

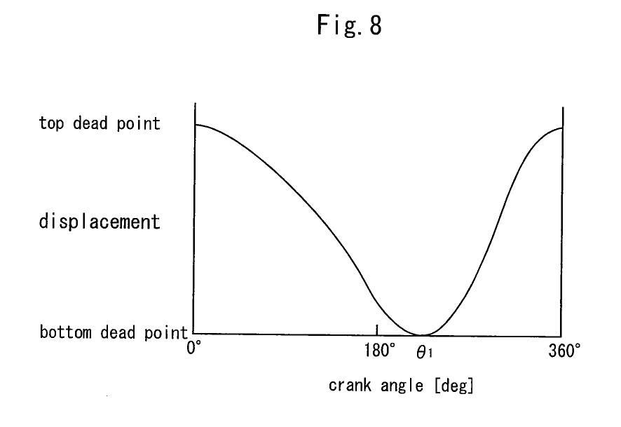

As the power transmitting mechanism 16, for example, as shown in the patent document 4, there is a mechanism in which the slide repeats the upward movement and the downward movement with respect to the rotation in one direction of the motor and the moving amounts of the slide are asymmetric between the downward moving time and the upward moving time with respect to the angle of rotation of the motor. The mechanism shown in the patent document 4 is constituted by a crank shaft and a link mechanism. A relation between a crank angle and a displacement of the slide 4 in the power transmitting mechanism mentioned above comes to, for example, as shown in FIG. 8. In FIG. 8, a slide moving amount is larger in a section between θₗand 360 degree, than a section between 0 degree and θ₁.

In the case of the power transmitting mechanism mentioned above, in the present invention, the slide 4 is moved up and down by utilizing the section in the side that the moving amount is larger with respect to the angle of rotation of the servo motor 3, by forward and backward rotating the servo motor 3 in the steps 2, 4, 6 and 8 including the movement of the slide 4. Since it is possible to shorten the moving time of the slide 4 by doing this, it is possible to quicken the die changing work.

In this case, in the embodiment mentioned above, the lower end position of the power transmitting mechanism 16 is measured by detecting the angle of rotation of the servo motor 3, however, it is possible to measure the lower end position of the power transmitting mechanism 16 by using a linear encoder or a linear scale.

In the embodiment mentioned above, the height of the slide adjusting mechanism 20 is measured by the linear encoder or the linear scale, however, the structure may be made such as to measure an angle of rotation of the slide adjusting mechanism driving motor 22 by a rotary encoder or a resolver, and calculate the height by using a conversion formula between the motor rotating angle and the height defined by the mechanism.

In the embodiment mentioned above, the height of the slide adjusting mechanism 20 is adjusted by driving the motor, however, may be adjusted by driving a hydraulic cylinder or a pneumatic cylinder.

In the embodiment mentioned above, the adjusting of the die height is executed in the step 5, however, may be executed in the other stages as occasion demands. In this case, it is necessary to decide the moving amount of the slide 4 while taking the adjusting amount of the die height into consideration, in the other step.

In the case of the servo press having no slide adjusting mechanism, the lower end position of the power transmitting mechanism may be moved by omitting the operation of the slide adjusting mechanism in the step 5 in FIG. 5, and correcting a difference between the slide lower surface height at the bottom dead point for producing by the current dies and the slide lower surface height at the bottom dead point for producing by the next dies. In this case, the operation is often executed such that the lower end of the power transmitting mechanism does not reach the bottom dead point even under the production, and the rotating direction of the servo motor is inverted before reaching the bottom dead point so as to move up the slide.

In the description mentioned above, the embodiment in accordance with the present invention is explained, however, the embodiment in accordance with the present invention disclosed above is provided only for exemplification, and the scope of the present invention is not limited to the embodiment of the present invention. The scope of the present invention is indicated by the description of claims, and includes all the modifications within the equivalent meaning and range to the description of claims.

What is claimed is:

1. A die changing method of a press machine capable of positioning a slide at an arbitrary position within a slide moving range by transmitting a rotating motion of a servo motor serving as a press driving source as an elevating motion of a slide via a power transmitting mechanism and controlling the servo motor, comprising:
a step of moving the slide to a position at which an upper die gets on a lower die;
a step of unclamping the upper die from the slide;
a step of moving up the slide to a predetermined position which does not reach a top dead point so as to make it on standby;
a step of taking out the upper and lower dies from the press machine and bringing the other upper and lower dies in the press machine;
a step of moving down the slide to a position for fixing the upper die to the slide;
a step of fixing the upper die to the slide; and
a step of moving up the slide to a position at which
a start of a press work is allowed.

2. The die changing method of a press machine as claimed in claim 1, wherein the press machine has a slide adjusting mechanism adjusting a die height, and the method includes a step of operating the slide adjusting mechanism so as to change a height of the slide adjusting mechanism from an adjusting height for executing a press work by an original die to an adjusting height for executing a press work by the next die.

3. The die changing method of a press machine as claimed in claim 2, wherein the step of changing the height of the slide adjusting mechanism is executed in parallel to a step of taking out the upper and lower dies from the press machine and bringing the other upper and lower dies in the press machine.

4. The die changing method of a press machine as claimed in claim 1, wherein the power transmitting mechanism of the press machine is constituted by a mechanism in which the slide repeats an elevation with respect to a rotation in one direction of the servo motor and moving amounts of the slide becomes asymmetric between a downward moving time and an upward moving time with respect to an angle of rotation of the servo motor, thereby moving up and down the slide by utilizing a section in the side that the moving amount is larger with respect to the angle of rotation of the servo motor, in the step including the movement of the slide in each of the steps.

5. A press machine comprising:
a servo motor serving as a press driving source;
a slide in which an upper die is attached to a lower surface so as to move up and down;
a die clamper fixing an upper die to the lower surface of the slide so as to be capable of being unclamped;
a power transmitting mechanism converting a rotational motion of the servo motor into an elevating motion of the slide; and
a control unit controlling at least the servo motor and the die clamper;
wherein the control unit capable of positioning the slide at an arbitrary position within a slide moving range by controlling the servo motor,
the control unit moves the slide at a position at which the upper die gets on the lower die at a time of changing the die, next controls the die clamper so as to unclamp the upper die from the slide, next controls the servo motor so as to move up the slide to a predetermined position which does not reach a top dead point and make the slide on standby, moves down the slide to a position for fixing the upper die to the slide after the upper and lower dies are taken out from the press machine and the other upper and lower dies are brought in the press machine, next controlling the die clamper so as to fix the upper die to the slide, and next controlling the servo motor in such a manner as to move up the slide to a position at which a start of a press work is allowed.

6. The press machine as claimed in claim 5, wherein the press machine further comprises a slide adjusting mechanism adjusting a die height, and
the control unit controls the slide adjusting mechanism in such a manner as to change a height of the slide adjusting mechanism for an adjusting height for pressing by the original dies to an adjusting height for pressing by the next dies, at a time of changing the die.

7. The press machine as claimed in claim 6, wherein the control unit executes the control for changing the height of the slide adjusting mechanism at a time of changing the die in parallel to a work that the upper and lower dies are taken out from the press machine and the other upper and lower dies are brought in the press machine.

8. The press machine as claimed in claim 5, wherein the power transmitting mechanism of the press machine is constituted by a mechanism in which the slide repeats an elevation with respect to a rotation in one direction of the servo motor and moving amounts of the slide becomes asymmetric between a downward moving time and an upward moving time with respect to an angle of rotation of the servo motor, and
the control unit controls the servo motor in such a manner as to move up and down the slide by utilizing a section in the side that the moving amount is larger with respect to the angle of rotation of the servo motor, at a time when the slide moves at a time of changing the die.
